(19) United States
(12) Patent Application Publication
(10) Pub. No.: US 2013/0114370 A1
(43) Pub. Date: May 9, 2013

(54) MAGNETICALLY-DRIVEN STIRRING STRUCTURE

(71) Applicant: PEI-CHUAN MA, Taipei City (TW)

(72) Inventor: PEI-CHUAN MA, Taipei City (TW)

(21) Appl. No.: 13/292,060

(22) Filed: Nov. 8, 2011

(51) Int. Cl. B01F 13/08

(52) U.S. Cl. 366/272; 366/274

(57) ABSTRACT

A magnetically-driven stirring structure includes a transmission base, and a cup can be mounted to the transmission base or positioned on the transmission base. The transmission base includes a rotary mechanism, and the rotary mechanism is coupled to a first magnetic member. The rotary mechanism is coupled to an operating member in such a way that the operating member is exposed outside the transmission base. With a second magnetic member being placed in the cup, in making or brewing a drink in the cup, through actuation caused by the operating member, the rotary mechanism is made rotating and driving the first magnetic member to rotate, whereby the second magnetic member placed in the cup is caused by magnetism to rotate in the same direction so as to achieve stirring of the drink contained in the cup.

### TECHNICAL FIELD OF THE INVENTION

The present invention generally relates to a magnetically-driven stirring structure, and more particularly to an agitation cup structure that adopts a simple operation to actuate a magnetic member disposed inside the cup to rotate in order to realize stirring of a drink contained in the cup without applying a spoon or a stirring bar and to make brewing of the drink easy and convenient.

### DESCRIPTION OF THE PRIOR ART

People use a spoon or a stirring bar to stir a drink, such as coffee and tea, after the drink has been made, in order to uniformly mix the brew with water. The conventional way of stirring drink must remove the spoon or stirring bar out of the cup, after stirring is done. This may cause undesired drips of drink remaining on and carrying by the spoon or stirring bar to fall on a tabletop or other articles, and thus contaminating the surroundings. Further, it is quite common that no spoon or stirring bar is immediately available when people are making a drink. This is surely a trouble for people making drinks. The present invention aims to solve such problems by allowing a drink that is being brewed to be stirred through simple actuation so as to make brewing of drinks easy and convenient.

### SUMMARY OF THE INVENTION

The primary objective of the present invention is to provide a magnetically-driven stirring structure, which allows a magnetic member placed in a cup to rotate through a simple actuation in making a drink so as to effect stirring of the drink contained in the cup without using any spoon or stirring bar, so that making or brewing a drink is made easy and convenient and the structure is applicable to various types or styles of cups and jars.

The above mentioned magnetically-driven stirring structure comprises a transmission base, and a cup can be mounted to the transmission base or positioned on the transmission base. The transmission base comprises a rotary mechanism, and the rotary mechanism is coupled to a first magnetic member. The rotary mechanism is coupled to an operating member in such a way that the operating member is exposed outside the transmission base. With a second magnetic member being placed in the cup, in making or brewing a drink in the cup, through actuation caused by the operating member, the rotary mechanism is made rotating and driving the first magnetic member to rotate, whereby the second magnetic member placed in the cup is caused by magnetism to rotate in the same direction so as to achieve stirring of the drink contained in the cup.

In the magnetically-driven stirring structure mentioned above, the rotary mechanism accommodated inside the transmission base comprises a gear train comprising gears of various sizes and the first magnetic member is coupled to the gear train. The gear train is set in mating engagement with a driving gear, which is coupled to the operating member that is made in the form of a rotating disc having the handle mounted thereto and exposed outside the transmission base. The operating member, when caused to rotate by the handle, drives the gear train to rotate and thus driving the first magnetic member to rotate.

In the magnetically-driven stirring structure mentioned above, the rotary mechanism accommodated inside the transmission base comprises a gear train comprising gears of various sizes and the first magnetic member is coupled to the gear train. The gear train is set in mating engagement with a driving gear, and the driving gear is coupled to a winding spring. The driving gear is coupled to the operating member that is made in the form of a rotating disc having the handle mounted thereto and exposed outside the transmission base. Rotating the operating member with the handle causes the winding spring to be tightened, whereby the winding spring may get gradually released to drive the gear train to rotate and thus driving the first magnetic member to rotate.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is a perspective view showing inside details of the present invention.

FIGS. 3 and 4 are views illustrating an operation of the present invention.

FIG. 5 is a perspective view of another embodiment of the present invention.

FIG. 6 is a perspective view showing inside details of said another embodiment of the present invention.

FIG. 7 is a perspective view of a further embodiment of the present invention.

FIG. 8 is a perspective view showing inside details of said further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

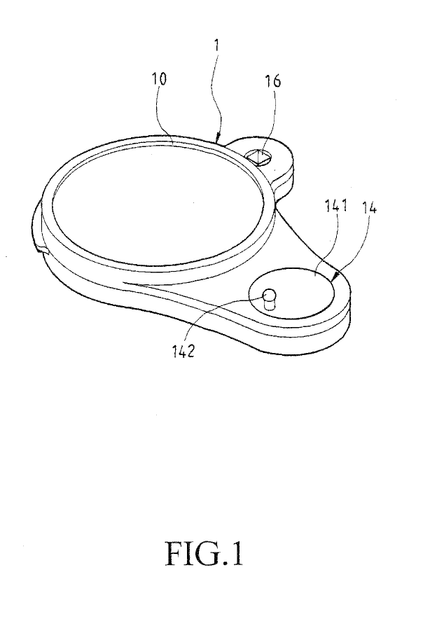

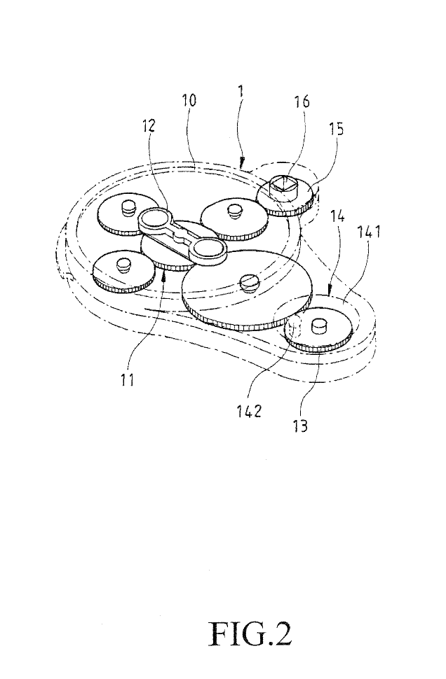

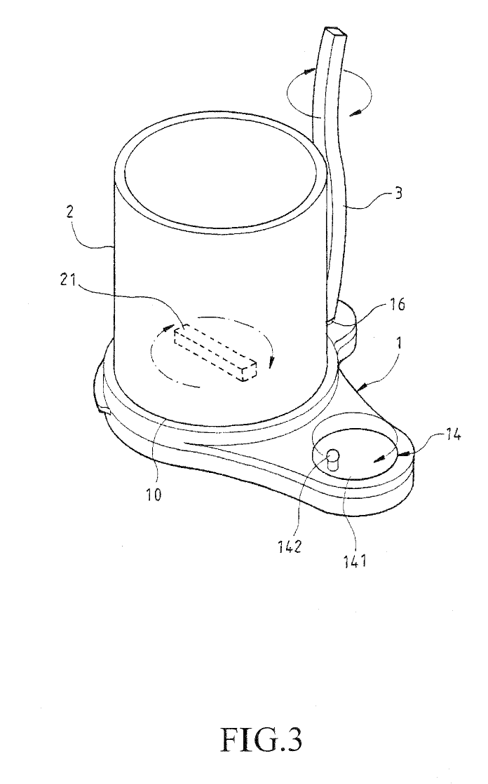

Referring to FIGS. 1 and 2, which are a perspective view of the present invention and a perspective view showing inside details of the present invention, as well as FIG. 3, these drawings show that the present invention comprises a transmission base 1. The transmission base 1 has a surface forming a positioning cavity 10. The transmission base 1 has a hollow interior accommodating therein a rotary mechanism. In the embodiment illustrated, the rotary mechanism comprises a gear train 11 that comprises a number of gears of various sizes. The gear train 11 has a top end to which a first magnetic member 12 (a magnet or an article with magnetism) is attached. The gear train 11 is set in mating engagement with a first driving gear 13, and the first driving gear 13 is coupled to an operating member 14 in such a way that the operating member 14 is exposed outside the transmission base 1. In the instant embodiment, the operating member 14 is set in a horizontal condition and comprises a disc 141 that has a surface having an outer circumferential edge to which a handle 142 is mounted. Thus, when the operating member 14 is driven to rotate by the handle 142, the gear train 11 is put into rotation so as to cause rotation of the first magnetic member 12. The gear train 11 is also in mating engagement with a driven gear 15 that is arranged at one side of the transmission base. The driven gear 15 comprises a socket member 16 (which comprises a square socket in the embodiment illustrated) mounted thereto, whereby when the gear train 11 is in rotation, the driven gear 15 is caused to rotate in unison therewith and thus drives the socket member 16 to rotate.

With the above described arrangement, to operate, a second magnetic member (a magnet or an article with magnetism) is first placed in a cup, whereby when a drink is to be made or brewed in such a cup, a user may operates the handle 142 to rotate the operating member 14, which in turn drives the gear train 11 and thus the first magnetic member 12 to rotate, allowing the second magnetic member disposed in the cup to be caused by magnetism to rotate in the same direction as that of the first magnetic member 12 and thus effecting stirring of the drink contained in the cup without using any spoon or stirring bar. Consequently, brewing or making a drink is made easy and convenient. The socket member 16, which is arranged at one side of the transmission base 1, may receive a curved bar to fit therein, so that the bar twists with the stirring operation of the stirring structure. This increases the interesting and fun in doing stirring.

Referring to FIGS. 3 and 4, which are views illustrating the operation of the present invention, these drawings show that to operate the present invention, a second magnetic member 21 is first placed into a cup 2 and a raw material of drink is put into the cup to add water for making or brewing the drink. The cup 2 is put into the positioning cavity 10 of the transmission base 1. The handle 142 is operated to rotate the operating member 14, which in turn drives the gear train 11 to rotate. As such, the first magnetic member 12 coupled to the gear train 11 is caused to rotate, and the second magnetic member 21 placed in the cup 2 is then caused by magnetism to rotate fast in the same direction as the first magnetic member 12 and thus effecting stirring of the drink contained in the cup 2. When the gear train 11 is in rotation, the driven gear 15 is driven to have the socket member 16 rotating therewith. A curved bar 3 can be selectively fit to the socket member 16 so that the bar 3 may twist following the stirring motion to increase the interesting and fun of doing stirring. The cup 2 can be of any desired style and shape and may be replaced by a jar in which the second magnetic member can be movably received.

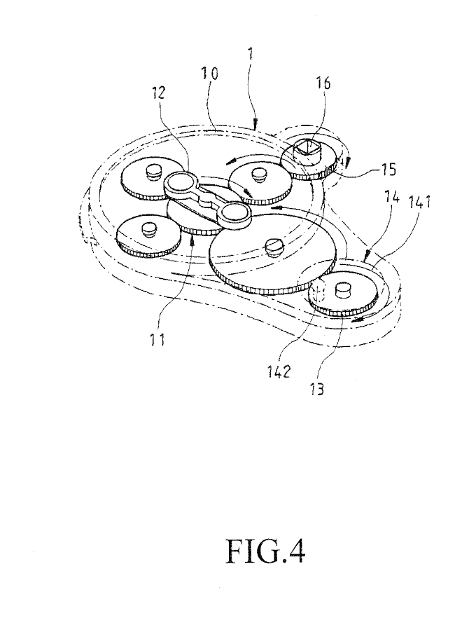

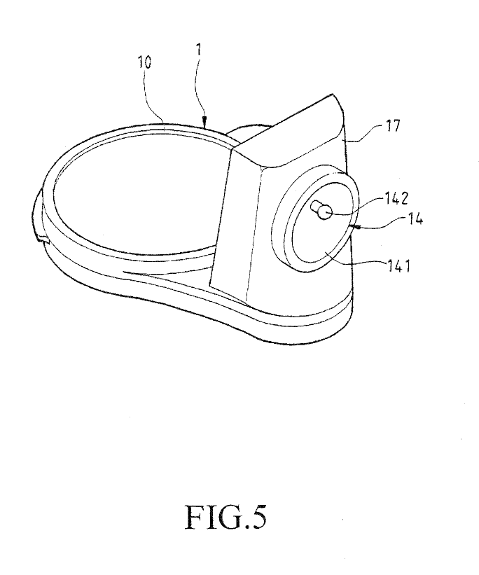

Referring to FIGS. 5 and 6, which are a perspective view of another embodiment of the present invention and a perspective view showing inside details of the present invention, as well as FIG. 3, these drawings show that as an alternative to the horizontally arranged operating member 14, a feasible arrangement is to form a raised portion 17 on the transmission base 1 and the gear train 11 and the first driving gear 13 are coupled, in a perpendicular fashion, to a second driving gear 18 and a third driving gear 19. The third driving gear 19 is coupled to the operating member 14 that is constituted by the disc 141. Smartly, the operating member 14 comprises the handle 142 mounted thereto in such a way that the operating member 14 is exposed outside the raised portion 17. When a user places a cup 2 in which a second magnetic member 21 is movably received on the transmission base 1, the handle 142 can be operated to rotate the operating member 14, which causes the gear train 11 to rotate in an opposite direction. As such, the first magnetic member 12 coupled to the gear train 11 is caused to rotate fast in the same direction, allowing the second magnetic member 21 received in the cup to be caused by magnetism to rotate in the same direction as that of the first magnetic member 12 thereby effecting stirring of the drink contained in the cup 2.

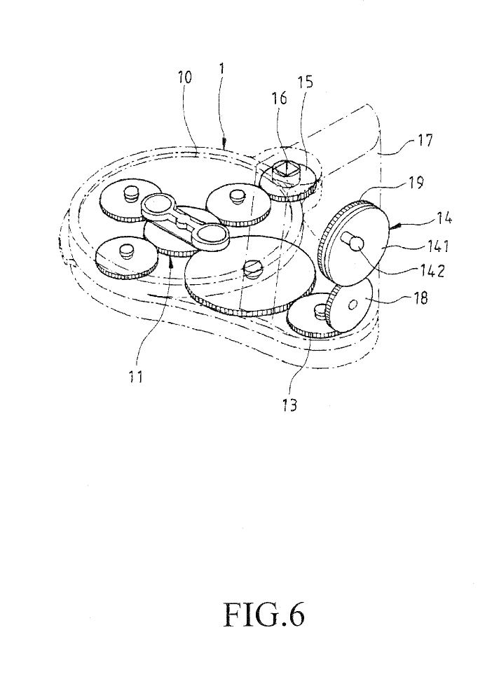

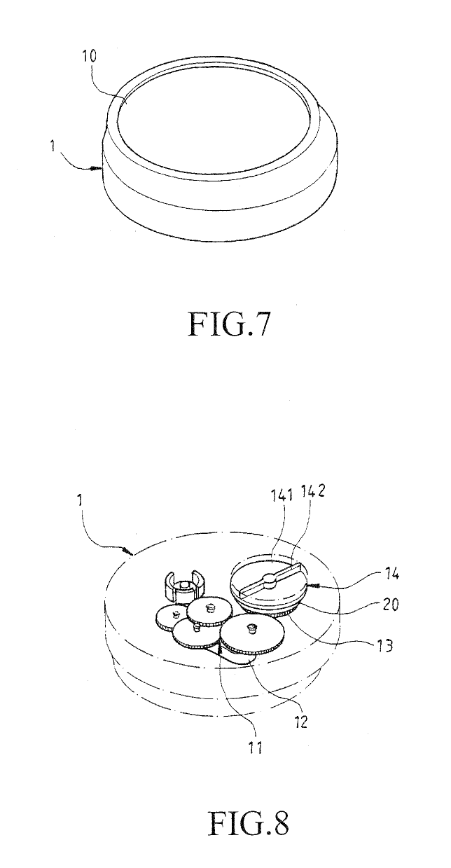

Referring to FIGS. 7 and 8, which are a perspective view of another embodiment of the present invention and a perspective view showing inside details of the present invention, as well as FIG. 3, these drawings show that the operating member 14 of the present invention may comprise a winding spring 20 that is coupled to the disc 141, so that rotation of the operating member 14 in a given direction may tighten the winding spring 20. This allows the winding spring 20 to get gradually released for driving the driving gear 13 and thus the gear train 11 to rotate. The rotation of the gear train 11 causes rotation of the first magnetic member 12, whereby with a cup 2 that receives a second magnetic member 21 therein being positioned in the positioning cavity 10 of the transmission base 1, the second magnetic member 21 located in the cup 2 is caused by magnetism to rotate in the same direction as that of the first magnetic member 12, thereby effecting stirring of the drink contained in the cup 2.

In summary, the present invention uses a transmission base that comprises a rotary mechanism and a magnetic member to receive a cup that comprises another magnetic member movably arranged therein to form a magnetically-driven stirring structure, whereby, in making a drink, through simple actuation, the magnetic member arranged in the cup is caused to rotate to effect stirring of the drink contained in the cup. The inconvenience of the conventional way of stirring that requires the use of a spoon or a stirring bar is thus eliminated, and brewing or making a drink is made easy and convenient.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A magnetically-driven stirring structure comprising a transmission base, the transmission base comprising a rotary mechanism, the rotary mechanism comprising a first magnetic member operatively coupled thereto, the rotary mechanism being coupled to an operating member in such a way that the operating member is exposed outside the transmission base, whereby with a cup receiving a second magnetic member movably arranged therein, in making a drink with the cup, through actuation made with the operating member, the rotary mechanism is caused to rotate and in turn drives the first magnetic member to rotate so that the second magnetic member arranged in the cup is caused by magnetism to rotate in the same direction to achieve stirring of the drink contained in the cup.

2. The magnetically-driven stirring structure according to claim 1, wherein the rotary mechanism comprises a gear train comprising gears of different sizes, the first magnetic member being coupled to a top end of the gear train, the gear train being in mating engagement with a driving gear, the driving gear being coupled to the operating member in such a way to have the operating member exposed outside the transmission base.

3. The magnetically-driven stirring structure according to claim 1, wherein the operating member comprises a disc, the disc having a surface to which a handle is mounted, whereby the operating member is caused to rotate by the handle for driving the gear train to rotate so as to rotate the first magnetic member.

4. The magnetically-driven stirring structure according to claim 3, wherein the disc is coupled to a winding spring, whereby when rotation of the operating member makes the winding spring tightened so that the winding spring is then selectively and gradually released for driving the gear train to rotate to cause rotation of the first magnetic member.

5. The magnetically-driven stirring structure according to claim 1, wherein the first magnetic member coupled to the gear train and the second magnetic member arranged in the cup are magnets.

6. The magnetically-driven stirring structure according to claim 1, wherein the transmission base comprises an enclosed box having a top surface forming a positioning cavity for receiving and positioning the cup.
